(19) United States
(12) Patent Application Publication
(10) Pub. No.: US 2003/0163369 A1
(43) Pub. Date: Aug. 28, 2003

(54) Electronic advertising display and public internet access system

(76) Inventor: Dane Arr, Tempe, AZ (US)

Correspondence Address: STONEMAN LAW OFFICES, LTD, 3113 NORTH 3RD STREET, PHOENIX, AZ, 85012, US

(21) Appl. No.: 10/085,580

(22) Filed: Feb. 26, 2002

(51) Int. Cl. G06F 17/60

(52) U.S. Cl. 705/14

(57) ABSTRACT

A computer controlled digital electronic display system for disseminating targeted public advertising, at select times and in select locations, in combination with a system for providing publicly available Internet access. It is designed to provide wireless connectivity between portable consumer electronics and the Internet. Also described is a business method for the placement of revenue generating Internet services including wireless based transactions, funded essentially by advertising revenue.

### BACKGROUND

This invention relates to systems for providing electronically displayed advertising in combination with public Internet access. More particularly, this invention provides a computer controlled Plasma Display Panel system for disseminating targeted public advertising, at select times and locations, in combination with a system for providing publicly available Internet access.

Recently, a wide range of interactive devices has been developed to provide information to a variety of users via communications networks. These interactive devices include, for example, computers connected to various computer on-line services, interactive kiosks, interactive television systems, a variety of other wired and wireless devices, such as personal data assistants (PDA's), and the like. In particular, the popularity of computer on-line services has grown immensely in popularity over the last decade. Computer on-line services are provided by a wide variety of different companies.

In general, most computer on-line services are accessed via the Internet. The Internet is a global network of computers. One popular part of the Internet is the World Wide Web, or the “Web.” The World Wide Web contains computers that display graphical and textual information. Computers that provide information on the World Wide Web are typically called “Web sites.” A Web site is defined by an Internet address that has an associated electronic page, often called a “home page.” Generally, a home page is an electronic document that organizes the presentation of text, graphical images, audio and video into a desired display. These Web sites are operated by a wide variety of entities, which are typically called “providers.”

A user may access the Internet via a dedicated high-speed line or by using a personal computer (PC) equipped with a conventional modem or a variety of other wired and wireless devices. Special interface software, called “browser” software, is installed within the PC or other access device. When the user wishes to access the Internet by normal telephone line, an attached modem is automatically instructed to dial the telephone number associated with the local Internet host server. The user can then access information at any address accessible over the Internet. Two well-known web browsers, for example, are the Netscape Navigator browser marketed by Netscape Communications Corporation and the Internet Explorer browser marketed by Microsoft Corporation.

Information exchanged over the Internet is typically encoded in HyperText Mark-up Language (HTML) format. The HTML format is a scripting language that is used to generate the home pages for different content providers. In this setting, a content provider is an individual or company that places information (content) on the Internet so that others can access it. As is well known in the art, the HTML format is a set of conventions for marking different portions of a document so that each portion appears in a distinctive format. For example, the HTML format identifies or “tags” portions of a document to identify different categories of text (e.g., the title, header, body text, etc.). When a web browser accesses an HTML document, the web browser reads the embedded tags in the document so it appears formatted in the specified manner.

An HTML document can also include hyperlinks, which allow a user to move from one document to another document on the Internet. A hyperlink is an underlined or otherwise emphasized portion of text that, when selected using an input device such as a mouse, activates a software connection module that allows the user to jump between documents or pages (i.e., within the same Web site or to other Web sites). Hyperlinks are well known in the art, and have been sometimes referred to as anchors. The act of selecting the hyperlink is often referred to as “clicking on” the hyperlink.

The business world wishes to sell products and services to the consuming public, including such services as public venue Internet access. In order to provide for the sale of these goods and services to the public, an important issue is the provision of advertising of the goods and services to the public. Furthermore, the sale of such advertising provides for a revenue stream to the business responsible for actually placing the advertising in front of the public. Thus, a need exists for new and innovative methods of advertising. A further business need is providing a publicly available Internet access venue. However, providing publicly available Internet access has at least one major drawback—the infrastructure cost. The infrastructure cost to provide for the system equipment and operation at the public locations, the controlling and monitoring systems, the broadband Internet access, the idle-time costs, etc., makes publicly available Internet access a costly financial venture.

However, the combining of such advertising needs with the needs of publicly available Internet access may be designed, in accordance with the present invention, to be financially stable from inception. Additionally, the combination of advertising and publicly available Internet access will also encourage and enable public Internet access in public venues, and in fact, further encourage public venue utilization of the Internet.

The revenue stream produced from the dissemination of targeted public advertising, at select times and locations, provides the revenue to fund the systems required for the placement of the public access Internet stations in public venues, and in turn, allows the targeted public advertising to be displayed upon such public Internet stations. Further elements of such public access Internet stations include such things as providing publicly available video conferencing in public venues, and providing wireless connectivity between portable consumer electronics and the Internet.

The above elements of advertising and publicly available wireless connectivity between portable consumer electronics and the Internet provides for satisfying multiple objectives in a cost effective manner that provides for a public Internet access venue system.

The word Bluetooth™ used herein refers to a specification for a small-form factor, low-cost radio based link between mobile computers, mobile phones and other portable handheld devices, and the Internet. Many large companies that produce such products are actively involved in the development of Bluetooth™ enabled products. This technology, protocol, and specification is now well known in the art and will be sometimes refereed to hereinafter as “Bluetooth”.

### GLOSSARY OF GENERAL TERMS AND ACRONYMS

The following terms and acronyms explained below as background and are used throughout the detailed description:

Client-Server. A model of interaction in a distributed system in which a program at one site sends a request to a program at another site and waits for a response. The requesting program is called the “client,” and the program, which responds to the request, is called the “server.” In the context of the World Wide Web, the client is typically a “Web browser”, which runs on a user's computer; the program which responds to Web browser requests at a Web site is commonly referred to as a “Web server.”

Domain Name System (DNS). An Internet service that translates domain names (which are alphabetic identifiers) into IP addresses (which are numeric identifiers for machines on a TCP/IP network).

Internet Information Server (IIS). Microsoft Corporation's Web server that runs on Windows NT platforms.

Internet. A collection of interconnected (public and/or private) networks that are linked together by a set of standard protocols to form a distributed network. While this term is intended to refer to what is now commonly known as the Internet, it is also intended to encompass variations, which may be made in the future, including changes and additions to existing standard protocols.

HyperText Markup Language (HTML). A standard coding convention and set of codes for attaching presentation and linking attributes to informational content within documents. During a document authoring stage, the HTML codes (referred to as “tags”) are embedded within the informational content of the document. When the Web document (or “HTML document”) is subsequently transferred from a Web server to a Web browser, the codes are interpreted by the Web browser and used to parse and display the document. In addition to specifying how the Web browser is to display the document, HTML tags can be used to create links to other websites and other Web documents (commonly referred to as “hyperlinks”). For more information on HTML, see Ian S. Graham, The HTML Source Book, John Wiley and Sons, Inc., 1995 (ISBN 0471-11894-4).

HyperText Transport Protocol (HTTP). The standard World Wide Web client-server protocol used for the exchange of information (such as HTML documents, and client requests for such documents) between a Web browser and a Web server. HTTP includes a number of different types of messages that can be sent from the client to the server to request different types of server actions. For example, a “GET” message, which has the format GET, causes the server to return the document or file located at the specified Universal Resource Locator (URL).

Java. A general purpose programming language developed by Sun Microsystems. Java has a number of features that make the language well-suited for use on the World Wide Web. Small Java applications are called Java applets and can be downloaded from a Web server and run on a personal computer by a Java-compatible Web browser, such as Netscape Navigator or Microsoft Explorer.

Java servlet. A small Java-based program designed to perform a specific task within a Web server environment. Java servlets are analogous to Java applets except the are designed to only run on the Web server.

Java Virtual Machine. A set of applications that create a run time environment for executing Java code.

JRun. A server-side extension that allows a Web server to execute Java servlets for the processing and display of information. JRun is a widely adopted engine for developing and deploying server-side Java applications that use Java Servlets and JavaServer Pages (JSP).

Java Database Connectivity (JDBC). A Java API developed by JavaSoft, a subsidiary of Sun Microsystems of Mountain View, Calif. JDBC enables Java programs to execute SQL statements, which allows Java programs to interact with any SQL-compliant database. Since many relational database management systems (DBMSs) support SQL, and because Java itself runs on most platforms, JDBC makes it possible to write a single database application that can run on different platforms and interact with different database management systems. JDBC is similar to ODBC but is designed specifically for Java programs, whereas ODBC is language-independent.

LAN (Local Area Network)—This term is sometimes used herein to refer to a system that links together electronic office equipment, such as computers and word processors, and forms a network within an office or building.

Open DataBase Connectivity (ODBC). A database access method developed by Microsoft Corporation. ODBC allows an application to access data from a database by translating the application's data queries into commands that the database management system (DBMS) can understand.

PDA (Personal Digital Assistant)—This term is sometimes used herein to refer to a small hand held computer with or without wireless access to the Internet. A lightweight, handheld, usually pen-based computer used as a personal organizer.

SOAP (Simple Object Access Protocol)—This term is sometimes used herein to refer to a lightweight protocol for exchange of information in a decentralized, distributed environment. It is an XML based protocol that consists of three parts: an envelope that defines a framework for describing what is in a message and how to process it, a set of encoding rules for expressing instances of application-defined data types, and a convention for representing remote procedure calls and responses. SOAP can potentially be used in combination with a variety of other protocols. World Wide Web Consortium definition (See http://www.w3.org/tr/soap).

Transmission Control Protocol/Internet Protocol (TCP/IP). A standard Internet protocol (or set of protocols) which specifies how two computers exchange data over the Internet. TCP/IP handles issues such as packetization, packet addressing, handshaking and error correction. For more information on TCP/IP, see Volumes I, II and III of Comer and Stevens, Internetworking with TCP/IP, Prentice Hall, Inc., ISBNs 0-13-468505-9 (vol. I), 0-13-125527-4 (vol. II), and 0-13-474222-2 (vol. III).

UML (Unified Modeling Language)—This term is sometimes used herein to refer to a graphical language for visualization, specifying, constructing, and documenting the artifacts of a software-intensive system. The UML gives you a standard way to write a system's blueprints, covering conceptual things, such as business processes and system functions, as well as concrete things, such as classes written in a specific programming language, database schemas, and reusable software components. The Unified Modeling Language User Guide: Grady Booch, James Rumbaugh, Ivar Jacobson. Addison-Wesley, Copyright 1999 ISBN 0-201-57168-4; The Unified Modeling Language Reference Manual: Grady Booch, James Rumbaugh, Ivar Jacobson. Addison-Wesley, Copyright 1999 ISBN 0-201-30998-X; UML In A Nutshell, A desktop quick reference: Sinan Si Alhir. O'Reilly & Associates, Inc., Copyright 1998 ISBN 1-56592-448-7; UML Distilled, second edition: Martin Fowler with Kendall Scott. Addison-Wesly, Copyright 2000 ISBN 0-201-65783-X.

Uniform Resource Locator (URL). A unique address which fully specifies the location of a file or other resource on the Internet. The general format of a URL is protocol://machine address:port/path/filename. The port specification is optional, and if none is entered by the user, the Web browser defaults to the standard port for whatever service is specified as the protocol. For example, if HTTP is specified as the protocol, the Web browser will use the HTTP default port. The machine address in this example is the domain name for the computer or device on which the file is located.

WAN (Wide Area Network)—This term is sometimes used herein to refer to a communications network that uses such devices as telephone lines, satellite dishes, or radio waves to span a larger geographic area than can be covered by a LAN.

World Wide Web (“Web”). Used herein to refer generally to both (1) a distributed collection of interlinked, user-viewable hypertext documents (commonly referred to as “Web documents”, “Web pages”, “electronic pages” or “home pages”) that are accessible via the Internet, and (2) the client and server software components that provide user access to such documents using standardized Internet protocols. Currently, the primary standard protocol for allowing applications to locate and acquire Web documents is the HyperText Transfer Protocol (HTTP), and the electronic pages are encoded using the HyperText Markup Language (HTML). However, the terms “World Wide Web” and “Web” are intended to encompass future markup languages and transport protocols that may be used in place of or in addition to the HyperText Markup Language and the HyperText Transfer Protocol.

XML (Extensible Markup Language)—This term is sometimes used herein to refer to the universal format for structured documents and data on the Web. World Wide Web Consortium definition (See http://www.w3.org/XML/).

### OBJECTS OF THE INVENTION

A primary object and feature of the present invention is to fulfill the above-mentioned needs by the provision of a computer-controlled advertising system that provides for disseminating targeted public advertising at selected times and locations. A further primary object and feature of the present invention is to provide such a system that provides public access Internet stations in public venues. Yet a further object and feature of the present invention is to provide such a system that provides wireless connectivity between portable consumer electronics and the Internet. Other objects and features of this invention will become apparent with reference to the following invention descriptions.

### SUMMARY OF THE INVENTION

According to a preferred embodiment of the present invention, this invention provides, a method, for providing a widely-distributed infrastructure, funded essentially by advertising revenues, of Internet locations, each having at least one advertising display unit, comprising: providing at least one website client-server system to assist media buyers to purchase and place advertising for display on a plurality of the advertising display units; providing assistance to location operators enabling placement at a plurality of locations of such at least one advertising display unit in such manner as to enable mass viewing at each such location; and providing for essentially each such advertising display unit to assist Internet access for location customers. Additionally, it provides such a method further comprising: providing a wireless electronic connectivity system structured and arranged to couple each advertising display unit of such plurality of advertising display units to at least one electronic device having a designated local wireless connectivity.

Moreover, it provides such a method further comprising: providing at least one video-conferencing interface structured and arranged to provide at least one video-conferencing interface between at least one first location-customer and at least one second location-customer in real-time. Moreover, it provides such a method further comprising: providing, for purchase by and delivery to such media buyer of marketing data collected at each advertising display unit. Additionally, it provides such a method further comprising: providing at least one video-conferencing interface structured and arranged to provide at least one video-conferencing interface between at least one first location-customer and at least one second location-customer in real-time; and providing, for purchase by and delivery to such media buyer of marketing data collected at each advertising display unit.

In accordance with another preferred embodiment hereof, this invention provides an Internet client-server system, comprising, in combination: at least one advertising delivery system comprising at least one computer server; a plurality of advertising display units, essentially each such advertising display unit comprising at least one client computer, electronically coupled to such at least one advertising delivery system; and a control system, comprising such at least one advertising delivery system and each of such plurality of advertising display units, structured and arranged to control a time and location of a targeted advertising message output from each of at least one subset of such plurality of advertising display units; wherein essentially each of such plurality of advertising display units comprise at least one access system structured and arranged to assist a plurality of users to access the Internet.

Additionally, it provides such a system wherein such at least one access system comprises at least one wireless electronic connectivity system structured and arranged to couple each advertising display unit of such plurality of advertising display units to at least one electronic device having a designated local wireless connectivity. Further, it provides such a system wherein personnel of such at least one advertising delivery system may control in real-time such time and location of such targeted advertising message output from each of such subset of such plurality of advertising display units. Moreover, it provides such a system further comprising at least one video camera, electronically coupled to each of a second subset of such plurality of display units, structured and arranged to transmit video information to such at least one advertising delivery system. And, it provides such a system wherein each of a third subset of such plurality of advertising display units comprises a subdivided window comprising separate windows for at least: media content; advertising; and web-cam views.

Additionally, it provides such a system further comprising at least one video-conferencing system, having video-conferencing capability, structured and arranged to be controlled by such control system. Furthermore, it provides such a system wherein such control system comprises at least one software control system structured and arranged to control the time and location of a targeted advertising message output from each of such plurality of advertising display units. Further, it provides such a system wherein such at least one software control system further comprises: at least one media-buyer computer interface structured and arranged to interface with at least one media buyer; at least one location-operator computer interface structured and arranged to interface with at least one location operator of at least one advertising display unit; and at least one location-customer interface structured and arranged to interface with at least one location customer. In addition, it provides such a system wherein such at least one software control system further comprises: at least one location-customer interface structured and arranged to interface with at least one location customer while such location customer is operating an electronic device having a local wireless connectivity to at least one advertising display unit.

Additionally, it provides such a system wherein such at least one software control system further comprises: at least one video-conferencing interface structured and arranged to provide at least one video-conferencing interface between at least one first location-customer and at least one second location-customer in real-time. Moreover, it provides such a system further comprising: at least one video camera, electronically coupled to each of a second subset of such plurality of display units, structured and arranged to transmit video information to such at least one advertising delivery system; and at least one video-conferencing system, having video-conferencing capability, structured and arranged to be controlled by such control system; wherein personnel of such advertising delivery system may control in real-time such time and location of such targeted advertising message output from each of such subset of such plurality of advertising display units; and wherein each of a third subset of such plurality of advertising display units comprises a subdivided window comprising separate windows for at least: media content; advertising; and web-cam views.

Additionally, it provides such a system wherein such control system comprises: at least one software control system structured and arranged to control the time and location of a targeted advertising message output from each of such plurality of advertising display units; wherein such at least one software control system further comprises: at least one media-buyer computer interface structured and arranged to interface with at least one media buyer; at least one location-operator computer interface structured and arranged to interface with at least one location operator of at least one advertising display unit; and at least one location-customer interface structured and arranged to interface with at least one location customer. And, it provides such a system wherein such at least one central software control system further comprises at least one location-customer interface structured and arranged to interface with at least one location customer while such location customer is operating an electronic device having a local wireless connectivity to at least one advertising display unit. Additionally, it provides such a system wherein such at least one central software control system further comprises at least one video-conferencing interface structured and arranged to provide at least one video-conferencing interface between at least one first location-customer and at least one second location-customer in real-time.

### BRIEF DESCRIPTION OF THE DRAWINGS

FIG. 1 shows a high-level overview diagram of a preferred embodiment of the computer-controlled display screen advertising system of the present invention, preferably utilizing a plasma display screen (hereinafter sometimes called a “PDP”).

FIG. 2 shows a simplified layout diagram of a preferred advertising PDP window of the present invention.

FIG. 3 shows a high-level overview diagram of a preferred embodiment of the PDP advertising system of the present invention.

FIG. 4 shows a high-level overview diagram of a method of use of the PDP advertising system in conjunction with a Personal Digital Assistant in a preferred embodiment of the present invention.

FIG. 5 shows a simplified functional diagram of a method of use of the PDP advertising system in conjunction with a Digital Camera in a preferred embodiment of the present invention.

FIG. 6 is a high-level block diagram of a preferred method of business for implementing the system of the present invention.

FIG. 7, is a high-level overview diagram of a preferred embodiment of the present invention.

FIG. 8, is a high-level overview diagram of a preferred embodiment of the present invention.

FIG. 9, is a high-level overview diagram of a preferred embodiment of the present invention.

### DETAILED DESCRIPTION OF A PREFERRED EMBODIMENT AND THE BEST MODE OF PRACTICE

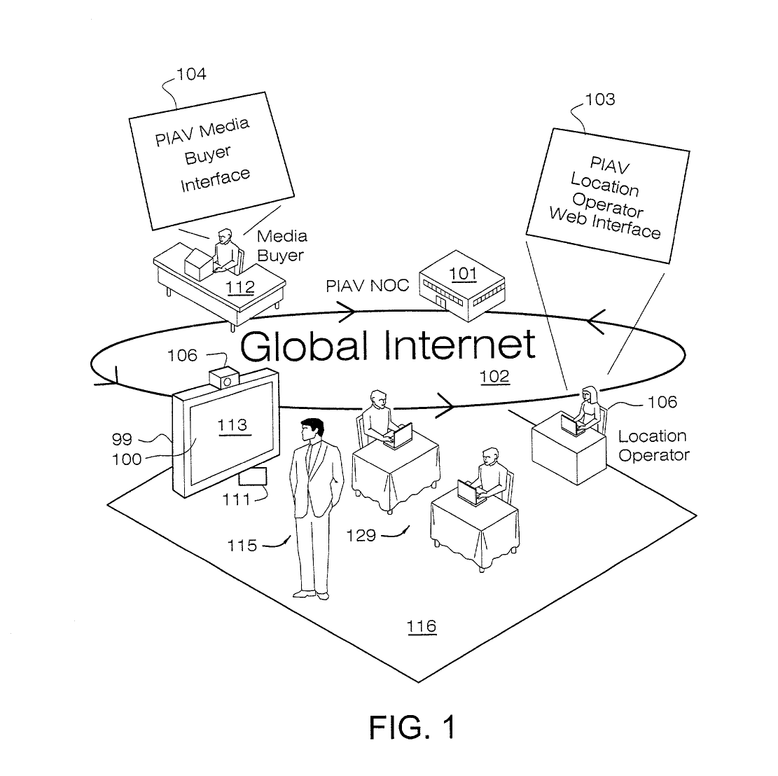

Referring to FIG. 1, a high-level overview diagram of a preferred embodiment of the display screen advertising system of the present invention is shown, preferably utilizing a plasma display screen. The Plasma Display Screen (“PDP” hereinafter) advertising system comprises the Public Internet Access Venue system (referenced herein as the acronym “PIAV”, a proprietary identifier) of the present invention. The PDP advertising system preferably comprises the PIAV screen 100, and is preferably a stand-alone PDP with the computer and associated hardware built into the display unit of the PIAV screen 100. The PDP advertising system further comprises a Public Internet Access Venue Network Operations Center(s) 101 (“NOC” hereinafter) comprising a server or servers upon which appropriate websites for the PDP advertising system, its operation, etc. are maintained (herein embodying at least one advertising delivery system comprising at least one computer server; and at least one software control system structured and arranged to control the time and location of a targeted advertising message output from each of such plurality of advertising display units).

The PIAV screen 100 is configured as a computer monitor display with all electronics such as a CPU, communications card, wireless ports, etc. integrated into the display unit of PIAV screen 100. Preferably complementing the hardware of PIAV screen 100 is a software system designed to enable the secure central control of the local hardware system through a web-browser-based interface 103 accessible from any computer on the Internet (herein embodying at least one location-operator computer interface structured and arranged to interface with at least one location operator of at least one advertising display unit). Such secure central control is preferably enabled utilizing software systems presently available. The PIAV screen 100 of the PDP advertising system is preferably coupled via the Internet 102, or such other network advertising content delivery and control system, to the PIAV NOC 101 (herein embodying a plurality of advertising display units, essentially each such advertising display unit comprising at least one client computer, electronically coupled to such at least one advertising delivery system). The PIAV NOC 101 preferably supplies the advertising content, video and/or audio, which is downloaded to each specific or designated PIAV screen 100.

Referring to FIG. 1, an example of an advertising, or media, purchase and placement upon a designated PIAV screen 100 is shown. Preferably, a typical media, purchase and placement comprises four primary steps: first, a media buy is placed over the internet 102 after analysis of available times and locations by the media buyer 112; secondly, at the PIAV NOC 101 the scheduling database checks for location operator 98 limitations and a confirmation is returned to the media buyer 112; next, the media buyer uploads advertising files and completes the transaction; finally, scheduled ad(s) 113 are shown to consumers within range of the PIAV screen 100, as shown. Preferably, the media content is disseminated as targeted public advertising, at selected times and locations (herein embodying a control system, comprising such at least one advertising delivery system and each of such plurality of advertising display units, structured and arranged to control a time and location of a targeted advertising message output from each of at least one subset of such plurality of advertising display units). If the data link to the local PIAV screen 100 is disabled, the local PIAV screen 100 is preferably able to run continuously on default programming providing screen content to local viewers 115 (it should be noted that the display of advertising will include appropriate audio content as will be understood by those skilled in the art). Media buyer(s) 112 of advertising for display upon a PIAV screen 100 of the PDP advertising system will preferably be equipped with their own web-based administration panel 104 for the selection of and control of the advertising content, as shown (herein embodying at least one media-buyer computer interface structured and arranged to interface with at least one media buyer). This will result in lower production costs, short lead times, ability to target groups by location and time of day, etc. Location(s) 116 where consumer(s) 114 are able to sit and read or chat are ideal for the PDP advertising system that can be controlled by the location operator 98, as shown. Preferably, the location operator(s) 98 can also use the PDP advertising system for their own promotional needs and may preferably enjoy veto-power over some types of content and competitive advertising.

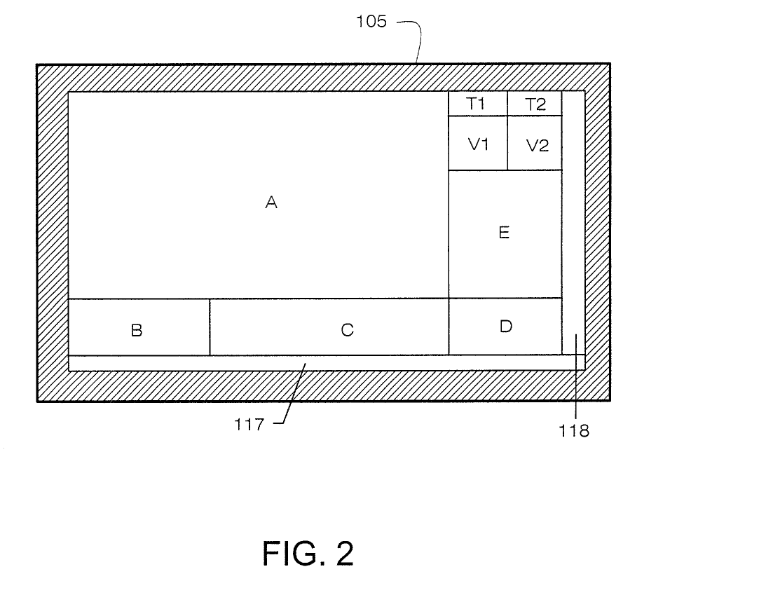

Referring to FIG. 2, a simplified layout diagram of a preferred advertising PDP window 105 of the present invention is shown. The advertising PDP window 105 is upon the display surface of each local PIAV screen 100 and provides for the display of a variety of information as both advertising content or media and other content. The advertising PDP window 105 is preferably subdivided into programmable, or addressable areas A-E, T1-T2, V1-V2, etc., in addition to the bottom section designated the “Portal Bar” and a side section entitled the “Stack” in which a queue of ads appears (herein embodying a system wherein each of a third subset of such plurality of advertising display units comprises a subdivided window comprising separate windows for at least: media content; advertising; and web-cam views). The advertising is represented by small label windows upon the portal bar of the Advertising PDP window, which in varying numbers preferably scroll from edge to edge, or other pattern so as to have each one continuously moving while on screen. The label windows move to the edge of the screen and off to reappear at the opposite end when its place in the queue is up so as to enable a larger number of label windows than are appearing on the screen. The images displayed on the main section A of the advertising PDP window are preferably periodically enlarged and reduced for optimum viewing from different distances.

Currently, while some electronically controlled advertising utilizing plasma display panels 99(“advertising PDPs” hereinafter) exist, the advertising providers providing such services are not Internet-based and do not utilize PDPs with integrated computers that can interact electronically on the Internet (herein embodying at least one location-customer interface structured and arranged to interface with at least one location customer). Thus, providing advertising PDP(s) 99, preferably such as a PIAV screen 100, that are coupled to the Internet 102 will allow the remotely controlled, automated placement of advertising upon selected advertising PDP(s) 99 of the PDP advertising system, in selected venues for a selected audience. The use of the PDP advertising system in which the advertising message is displayed upon large scale Advertising PDP(s) 99 allows targeting precise localities, having substantial foot traffic, and targeting precise times with the highest quality message, factors that allow premium pricing for this advertising venue. Additionally, unlike traditional “billboard”, or large picture type advertising, the use of the advertising PDP 99 allows the sale and placement of full motion advertising to local, regional and national clients, again with a high selectability available.

Because each 99 is computer controlled and also coupled via a high bandwidth connection to the Internet, each advertising PDP 99 station, in addition to the advertising images, may also feature other forms of motion video, i.e. MPEG's, VCR, LaserDisc, Video CD, etc. as well as still type graphics. These different content messages may be mixed together upon each selected advertising PDP 99 using techniques such as graphics keyed over a video or a “Picture in a Picture” with surrounding images, etc.

Furthermore, the advertising PDP 99 of the PDP advertising system will be very useful to businesses that cater to foot traffic. Such businesses typically have signs to inform the public of things such as, who they are, what they sell, where to enter, where to pay, what is on special, etc., in order to facilitate operation of their businesses. Preferably, advertisers can also use the PDP advertising system for marketing research prior to investing in other media that is less interactive, making it very valuable for determining the consumers “sweet spot”.

As previously mentioned, barriers to public venue Internet access include the cost of the installation and its operation and maintenance. Moreover, although some attempts are being made to provide wireless Internet access, to date such access is expensive, slow and undependable, or unavailable inside buildings where consumers need it. Although handheld devices now available have a wireless local area network chip integrated on the printed circuit board that can be used to provide access via a low-power connection to a nearby server, numerous barriers to the effective utilization of this technology still exist. Among these barriers are high start-up costs, slow consumer acceptance, and installation complexity. For instance, unambiguous cues that alert consumers when they are near a wireless Internet server, may pay for access, or will be notified about special offers have not been developed. Viable business methods allowing a wireless Internet location operator to benefit from providing space and support for consumers have not been established; further, sales of wireless technology products have been constrained by the limited availability of online wireless ready locations worldwide.

Preferred embodiments of the present invention provide a solution to the above problems. The PDP advertising system, preferably comprising a PIAV screen 100, further provide features including video-conferencing (herein embodying the step of providing at least one video-conferencing interface structured and arranged to provide at least one video-conferencing interface between at least one first location-customer and at least one second location-customer in real-time). A digital video camera 106 (as shown in FIG. 1) is preferably included with each PIAV screen 100 for the purposes of providing digital still pictures or “cam views” to a PIAV-provided web page for use by the location operator 98 and further provides the ability for the local display owner, or other company, to sell location-hosted Internet video conferencing meetings between any number of location(s) 116 (herein embodying a system comprising at least one video camera, electronically coupled to each of a second subset of such plurality of display units, structured and arranged to transmit video information to such at least one advertising delivery system). It should be noted, as may be preferable depending on appropriate circumstances known to those skilled in the art, that a digital video camera 106 may actually comprise an analog video camera whose signal is converted to digital form. When video-conferencing is not taking place, the digital video camera 106 preferably provides digital stills on a periodic or streamed basis to the location's web site “cam-view” page and/or upon PIAV Website(s). Further, the views generated by the digital video camera 106 are preferably packaged with banner advertising and links to other web sites. In addition, national or regional businesses can contract with location(s) 116 like coffee shops to host presentations (preferably delivered through the PIAV NOC 101, herein embodying at least one video-conferencing system, having video-conferencing capability, structured and arranged to be controlled by such control system) for groups like multilevel sales organizations or franchised services. Preferably, owners of location(s) 116 can offer a choice of “advertiser-supported” or “full screen” choices with a plurality of cameras displayed on the screen of the advertising PDP 99 simultaneously. Yet another feature is that owners of location(s) 116 can preferably host ongoing public meetings for a variety of interest groups as a means to build traffic during traditionally slow times for their businesses. Preferably, an owner of a location 116 can offer prepared programs, preferably created and uploaded by the interest groups headquarters through the PIAV NOC, using the location 116 for a meeting with the program displayed upon the PDP advertising system.

Additionally, the advertising PDP 99, preferably either as part of a video conferencing session, or as part of advertising dissemination, or for another purpose such as public entertainment, may display movies. The movies may be downloaded from the Internet and displayed upon the advertising PDP 99 of the PDP advertising system. The advertising PDP 99 will preferably comprise sufficient disc storage space to accommodate multiple movies in addition to the advertising media content and other required software. The entertainment content in addition to movies may preferably comprise targeted content, such as streaming video of current events, movies, movie trailers, etc. Additionally, as the PDP advertising system is a computer based device, the addition of appropriate I/O devices, such as keyboards, could allow a local advertising PDP 99 to host multi-user games, etc. Additionally, each advertising PDP 99, as desired in appropriate circumstances, may be configured and equipped to allow local customer(s) 114 access to the Internet for web browsing. Additional equipment preferably included with preferred embodiments of the present invention may comprise: wireless video cameras, wireless clip-on microphones, wireless web terminal(s), wireless game terminal(s), etc.

The ability of the PDP advertising system to enable two-way communication will also function as a device to attract local viewers 115 that will increase advertising effectiveness in public/private pedestrian areas. In addition, two advertising PDP screen(s) 99 may preferably be placed back to back in a single enclosure for mounting inside a store's front window or a second LAN-connected screen facing another level or area might be mirroring the same images as the first advertising PDP screen.

A major feature and advantage of the PDP advertising system of the present invention is that consumer interactive devices such as personal digital assistants (PDAs), handheld or laptop computers, digital cameras, mpeg players and numerous others owned by consumers will connect easily to the advertising PDP Screen, eliminating the need for company-furnished hardware that can be stolen, lost or damaged.

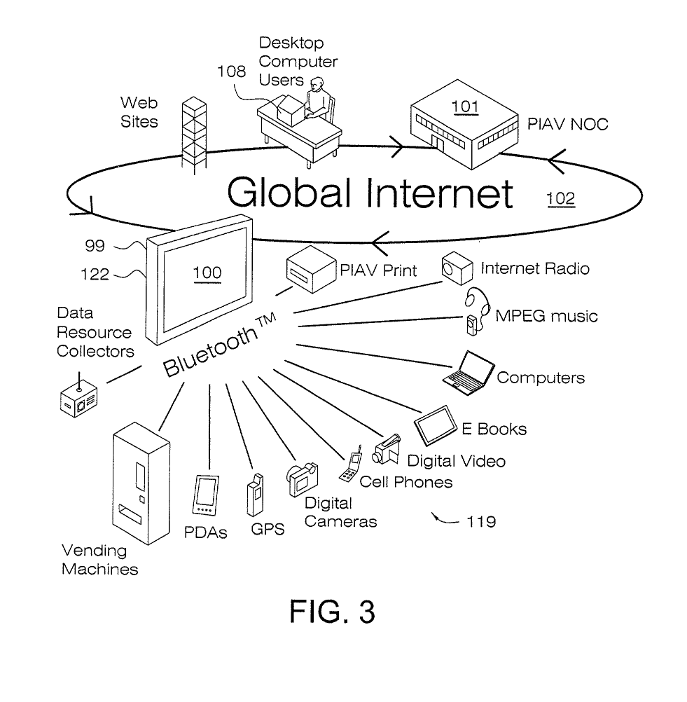

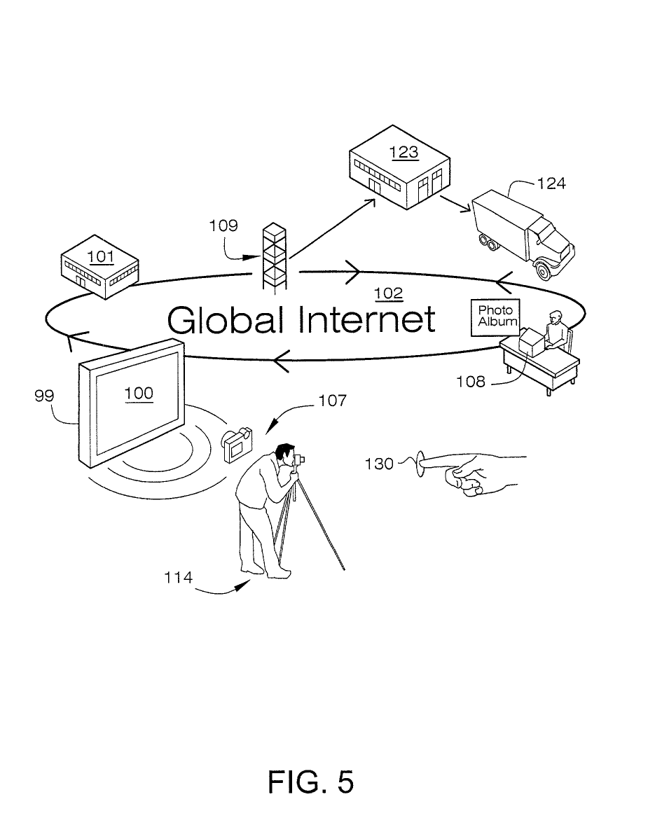

Referring now to FIG. 3, a high-level overview diagram of a preferred embodiment of the PDP advertising system of the present invention is shown. Another important feature of embodiments of the present invention is its ability to couple to third party wireless devices 119, as shown (herein embodying the step of providing a wireless electronic connectivity system structured and arranged to couple each advertising display unit of such plurality of advertising display units to at least one electronic device having a designated local wireless connectivity; and herein embodying at least one location-customer interface structured and arranged to interface with at least one location customer while such location customer is operating an electronic device having a local wireless connectivity to at least one advertising display unit). As previously discussed, the infrastructure cost to provide for the system equipment and operation at public locations for public Internet access venues is a costly financial venture. However, new technology like cell phone/organizers and wireless connection systems such as Bluetooth wireless connectivity are changing how people acquire and use data. Thus, the preferred feature of providing a connection point for those with such wireless devices 119 is yet another way to attract patrons to brick and mortar businesses, where they may be exposed to advertising, etc. Preferably, in addition to major revenue from advertising display, an advertising PDP 99 may generate additional revenue through its role as a “net services vending machine” 122 (herein embodying a system wherein essentially each of such plurality of advertising display units comprise at least one access system structured and arranged to assist a plurality of users to access the Internet). As shown in FIG. 3, Bluetooth-equipped wireless devices 119 preferably comprise PDAs, GPS devices, Digital Cameras, Cell Phones, etc. Each Bluetooth-equipped wireless device 119 may preferably carry its own unique features. For example (with specific reference to FIG. 5), digital cameras 107 may communicate via Bluetooth (or similar wireless system) as a matter of convenience for users to manage photos on their own PCs 108. Thus, an opportunity to package “out-of-home” access to digital camera related services via the Internet 102 is made available in preferred embodiments of the present invention. Preferably, in the example shown (FIG. 5), a user's digital camera content is uploaded, via the wireless interface of the PIAV screen 100 which is programmed to recognize the special device codes of the wireless devices 119, as shown (or by pushing a button 130 on the PIAV screen 100). Preferably, the camera content is sent by the PIAV screen 100 to the PIAV NOC 101 which directs the content to a portal web site 109 for direction to photo processing services, as shown. The customer('s) 114 photos are processed and delivered via internet or parcel service to the customer 114, as shown.

Furthermore, camera software comprising Bluetooth (or similar) code could preferably enable users to use an advertising PDP 99 to upload photos from their digital camera to a camera manufacturer or developer's website. The advantage of this is that customer(s) 114 could save photos to disk, retrieve them later from home, or even where such customer 114 has neither an Internet account nor a PC send them to a photo processor for processing and subsequent delivery. Thus, several problems at once are eliminated, including photo storage while away from home, which reduces the obstacle of limited memory in digital cameras 107, eliminates the hassle of processing one's own photos and provides access to them by others, etc. In addition, an advertising PDP 99 located where travelers or business people have access can use its hard disk to cache photos and upload them when bandwidth is available.

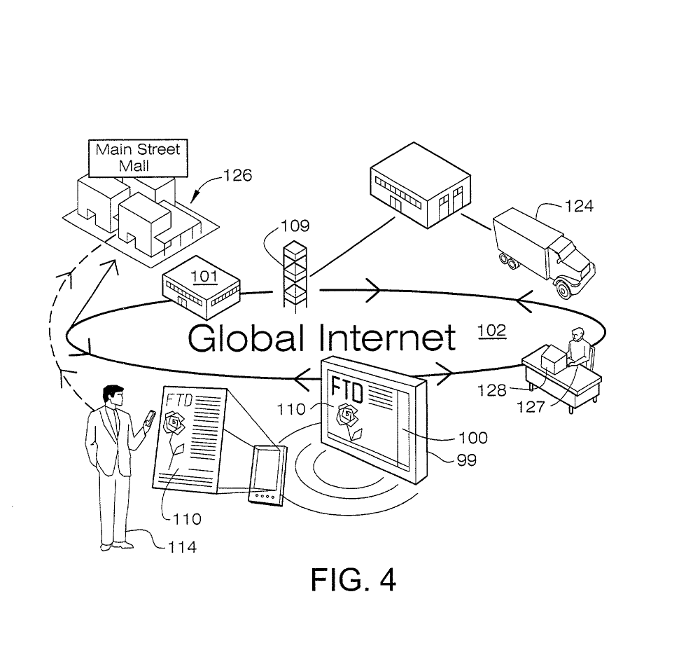

Yet, a further feature of embodiments of the preferred invention comprising Bluetooth (or similar) connectivity is that advertisers can target location(s) 116 and times with both passive and active information. Present systems may be preferably configured so that consumers within proximity of an advertising PDP 99 will see a selected message on the screen while their digital devices connect to the wireless data port for prearranged information downloads. If the consumer is interested, the ability to connect to a remote web site and receive services or complete a transaction can be activated with a single control link on one's Bluetooth (or similar) device. For example, referring to FIG. 4, a customer 114 viewing an FTD ad 110 upon an advertising PDP 99 could connect via their Bluetooth equipped PDA 125, to initiate a purchase from an Internet virtual store or mall website 126 and have flowers delivered via parcel service 124 to a designated recipient 127, as shown. The user could further electronically contact the designated recipient 127 and supply them with the URL of the advertising PDP 99 in front of which the user is located. The designated recipient 127 could then direct their home PC 128 to that site and view the customer 114 who arranged for the flower delivery.

A further feature of preferred embodiments of the present invention is a Bluetooth-enabled web terminal 111 with a credit card magnetic strip reader to be used by patrons while sitting at their tables 129(as shown in FIG. 1). It would preferably have its own screen and keyboard and function as a terminal on an advertising PDP 99. Additional features of the instant PDP advertising system preferably comprise security monitoring utilizing the Internet broadband connectivity in conjunction with the digital cameras and related microphones for location monitoring. Additional wireless security sensors could preferably comprise contact sensors, photo sensors, motion detectors, poison gas detectors, smoke detectors, etc.

Yet other features of preferred embodiments of the present invention may preferably comprise, where appropriate: customer support connectivity—advertising PDP locations providing the ability for customer(s) 114 to connect to a national support desk to deal with questions about products and services offered by the location owner of PIAV screen 100; weather data such as temperature, wind speed, wind direction, barometric pressure and air quality monitors coupled via Bluetooth (or similar) to the PIAV screen 100 and thence to the Internet 102 from where the data can be aggregated into a view of weather patterns throughout the area; street traffic monitoring, using the wireless capability to offer web-cam views or gate array radar counters for an emerging market in urban traffic aids for Internet equipped cars; and shopping services in which the advertising PDP 99 allows the download of electronic files via an Infrared transceiver or Bluetooth wireless connection built into the advertising PDP 99. Preferably, this shopping services feature may be used in conjunction with advertising to enable the handheld wireless devices 119 to download information that can be used to purchase items or services. This service will preferably interface with the advertising display purposes of the advertising PDP 99.

As an example of a usage of a preferred embodiment of the PDP advertising system, imagine a user on a business trip to the home office. After the day's work is done, the user stops for coffee at one of the shops near the user's hotel. When he/she arrives there, he/she notices that the shop has a PIAV screen 100 and web camera setup, i.e. an advertising PDP 99 of the PDP advertising system, sending pictures to the PDP advertising system website. Sitting at a table within view of the digital video camera 106 coupled to the advertising PDP 99, the user takes out a cell phone and calls home or a friend. When the user's spouse or friend, for example, answers, the user gives the URL of the digital camera view coupled to the advertising PDP 99 of the PDP advertising system and the spouse or friend may bring up the PDP advertising system website—upon which the user may now be viewed. Thus, an opportunity is provided for the family/group to interact while one member is away on business.

The digital camera view remains on the advertising PDP 99 of the PDP advertising system, and upon the home PC of the called spouse, for the duration of the phone call. Thus, advertisement exposure takes place to both parties. Additionally, the user, having been watching the digital camera view on the advertising PDP 99 of the PDP advertising system is further exposed to advertising showing entertainment, dining and shopping establishments within walking distance of the user's hotel, thus, further advertisement exposure takes place. As the user and spouse/friend will both continue to view the advertising PDP 99 of the PDP advertising system as long as on the phone, this makes it a powerful advertisement delivery venue.

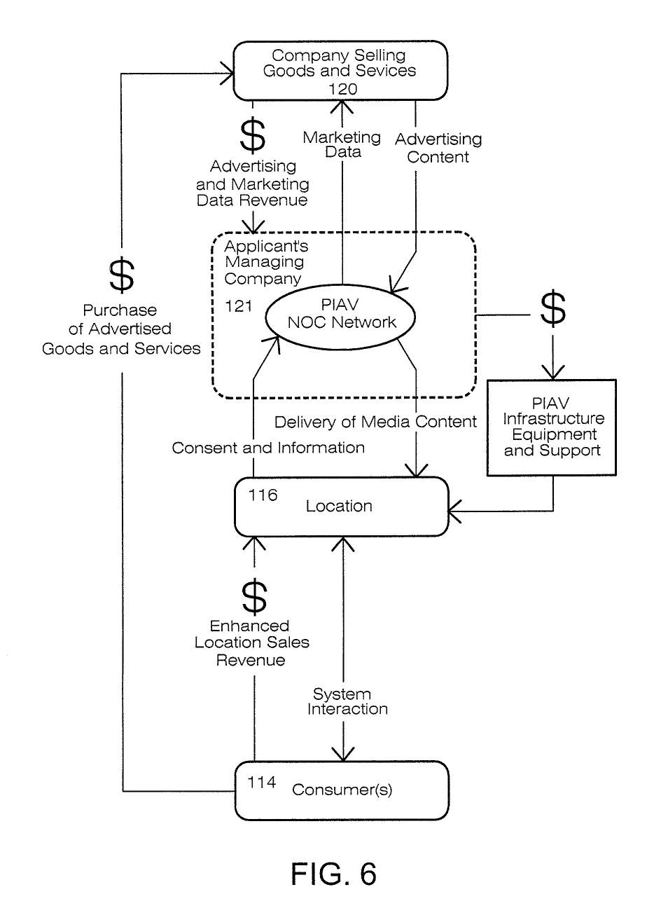

Preferably, the described embodiments of the present invention provide a business method for establishing widely-distributed Internet locations, funded essentially by advertising revenue, and also enabled to provide an infrastructure of Bluetooth (or similar wireless-enabled) locations for providing Internet and other services to users having, Bluetooth-enabled devices in the vicinity of such a location. FIG. 6 is a high-level block diagram of a preferred method of business in which the system of the present invention may be implemented. In accordance with the present invention, at least one transaction fee is paid by business 120 to the applicant's managing company 121 for delivery of advertising, via the client server system of the PIAV NOC 101 (herein embodying the step of providing at least one website client-server system to assist media buyers to purchase and place advertising for display on a plurality of the advertising display units), at least one customer 114 (exemplary of any number of customers) in at least one PIAV equipped location 116. Preferably, the revenue generated through PIAV advertising is used, in part, to establish and equip new PIAV location(s) 116 (herein embodying the step of providing assistance to location operators enabling placement at a plurality of locations of such at least one advertising display unit in such manner as to enable mass viewing at each such location). Since the PIAV NOC system (and applicant's managing company 121) has access to specific, demographic and usage information for all of its PIAV location(s) 116, the applicant's managing company 121 can compile marketing data to aide a media buyer, of the business 120, in selecting content, preferred delivery times, locations, etc. Additional revenue is generated when the business 120 purchases the collected marketing data regarding the usage habits and demographic make-up of PIAV location customer(s) 114 from the applicant's managing company 121 (herein embodying the step of providing, for purchase by and delivery to such media buyer of marketing data collected at each advertising display unit). Thus, the applicant's managing company 121 is able to develop at least two important revenue generators to fund further infrastructure development. Under appropriate circumstances, other revenue producing marketing and related services may be provided by the applicant's managing company 121.

Preferably, the local owner, or operator of the location 116 is not required to fund the installation or support of the PIAV system. Preferably, the operation and support responsibility of the location 116 is limited, comprising the furnishing of physical space to locate the system, media placement consent, and allowance of the PIAV NOC 101 to collect marketing data regarding the PIAV usage. Under appropriate circumstances, other business arrangements between the location 116 and the applicant's managing company 121 may be arranged to allow a PIAV system to placed within smaller venues (e.g. an equipment rental or leasing arrangement). Preferably, the PIAV equipped location 116 benefits from increased sales revenue driven by the added customer(s) 114 attracted to the PIAV Internet services (herein embodying the step of providing for essentially each such advertising display unit to assist Internet access for location customers). The business 120 benefits from revenue returns from the purchase of the advertised goods and services.

It is also seen that the described embodiments of the present invention provides a useful central software system for the PIAV NOC 101 which assists the performing of the many useful functions above described, including the provision of suitable interfaces for use by media buyer(s) 112, location owners, traveling users, conferences, etc., to enable efficient and economic use of the described embodiments of this invention.

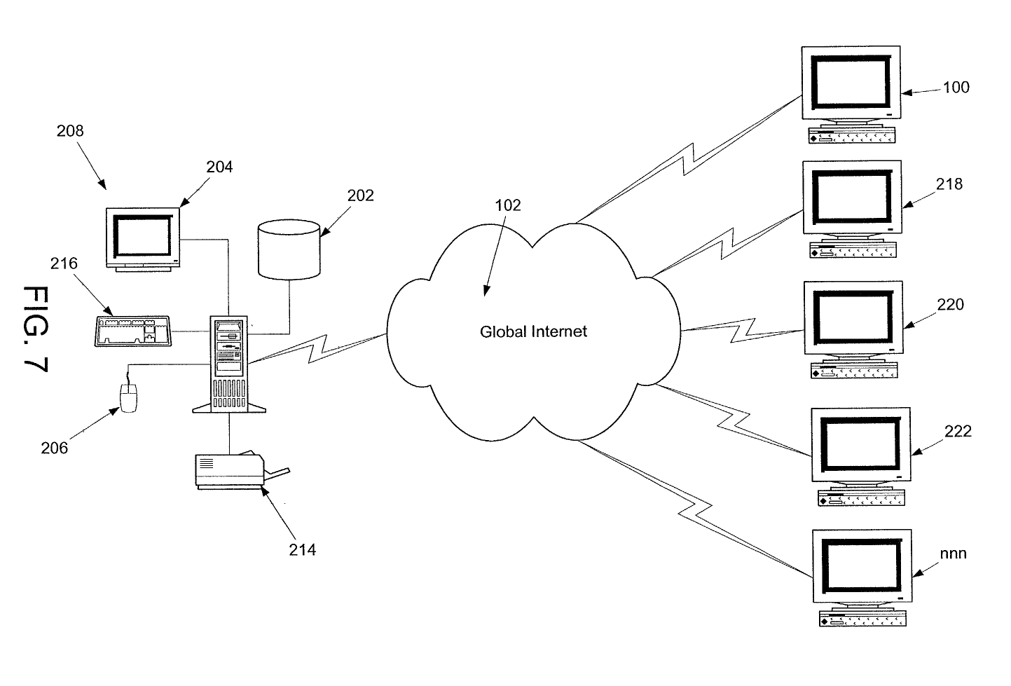

Referring now to FIG. 7, an overview of a preferred embodiment of the present invention is shown. The present invention preferably comprises a computer system 208. The computer system 208 comprises proprietary input and output devices as devices well known in the art. For example, the computer system 208 preferably comprises at least one PC comprising a screen or monitor 204, a keyboard 216, a printer 214, a mouse 206, etc. The computer system 208 further preferably comprises a database 202 for storage of the data and software comprising preferred embodiments of the present invention. The computer system 208 is preferably connected to the Internet 102 that serves as the presently preferred communications medium. The Internet 102, as previously discussed, comprises a global network of networks and computers, public and private. The Internet 102 is the preferable connection method for at least one PIAV screen 100 and other users 218, 220, 222 and nnn in preferred embodiments of the present invention.

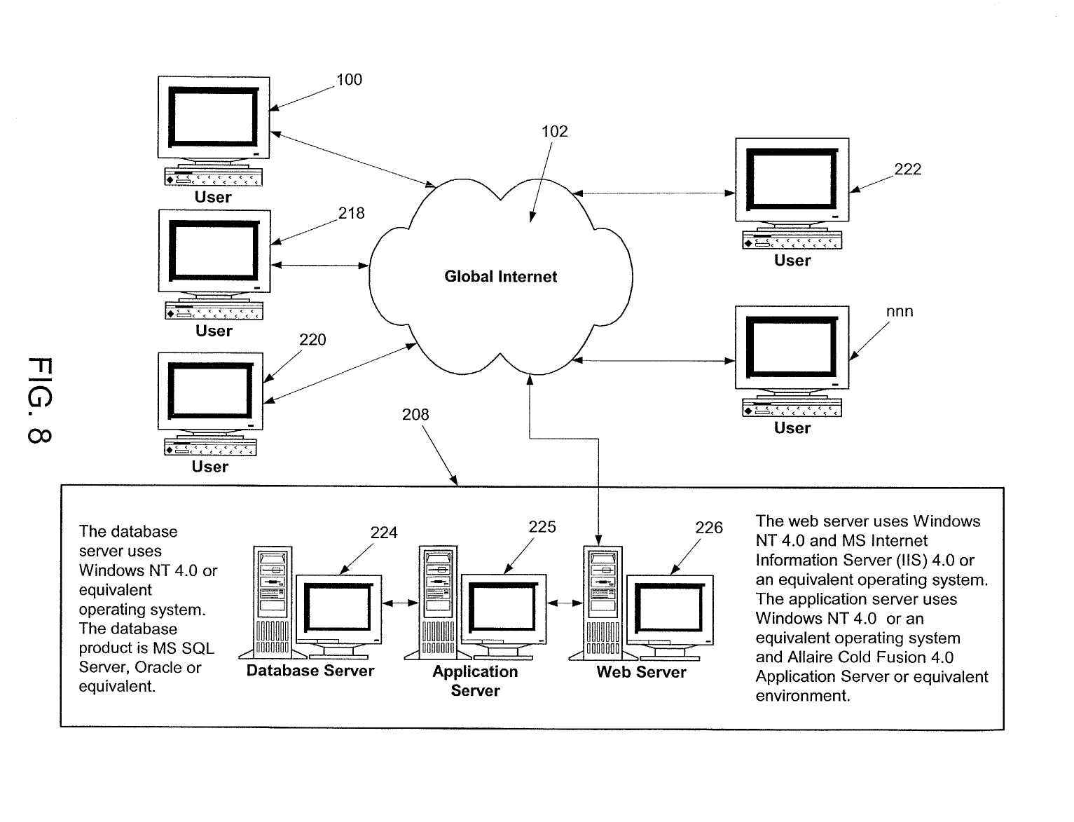

Referring now to FIG. 8, the computer system 208 is shown in more detail. The computer system 208 in a preferred embodiment comprises a database server 224, an application server 225 and a web server 226. The database server 224 preferably uses a Windows NT 4.0 or equivalent operating system environment and preferably utilizes MS SQL Server, Oracle or equivalent as the database engine. The application server 225 preferably runs in a Windows NT 4.0 or equivalent operating system environment using Allaire Cold Fusion 4.0 Application Server or an equivalent system to manage the preferred application software. The web server 226 also preferably runs in a Windows NT 4.0 or equivalent operating system environment. Preferably, the web server 226 operates only as the web server.

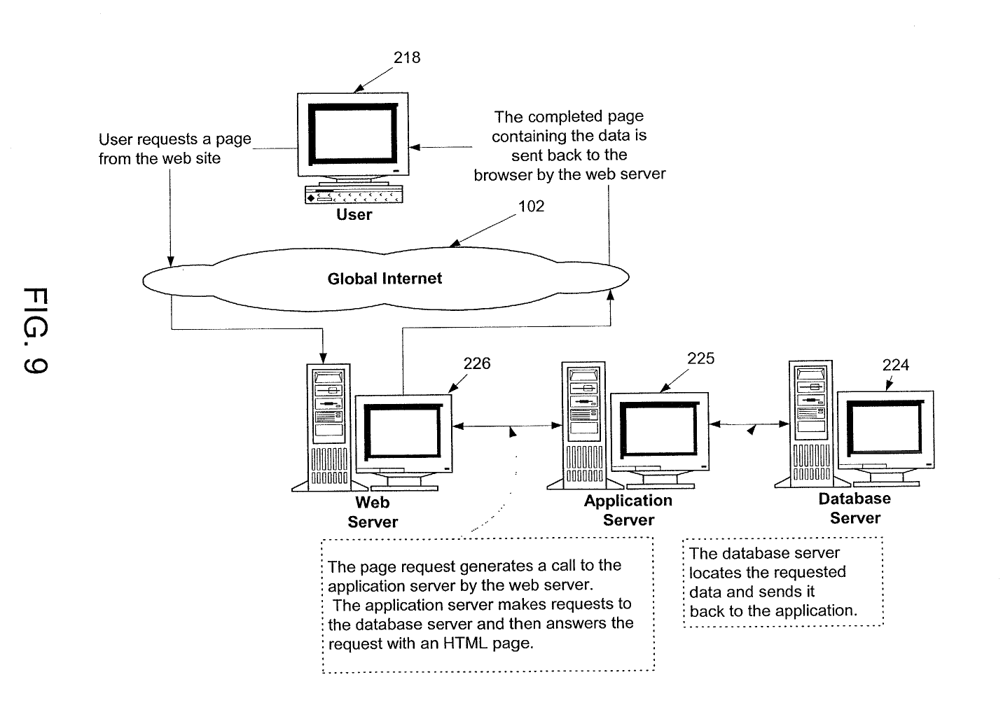

Referring to FIG. 9, a simplified functional diagram of a preferred embodiment of the present invention is shown. This figure shows the preferred relationships between a user 218 (exemplary of any number of users 218, 220, 122, nnn), the internet 102, the web server 226, the application server 225 and the database server 224. As shown, a user 218 requests at least one page from the PIAV NOC 101 web site of the present invention. The user 218 is preferably connected via the internet 102, and the web page request initiates a call to the present invention. The present invention then makes at least one request to the database server 224, and generates an HTML page for transmission to the user 218 following the database server's completion of the present invention's request and transmission of the requested data back to the web server 226. The web server 226 transmits the completed HTML page containing the data requested by the user 218 through the Internet 212 to the user 218.

Further, many other objects, features, and advantages of applicant's invention will be apparent to those skilled in the art from the above descriptions and the below claims.

What is claimed is:

1) A method for providing a widely-distributed infrastructure, funded essentially by advertising revenues, of Internet locations, each having at least one advertising display unit, comprising:
a) providing at least one website client-server system to assist media buyers to purchase and place advertising for display on a plurality of the advertising display units;
b) providing assistance to location operators enabling placement at a plurality of locations of said at least one advertising display unit in such manner as to enable mass viewing at each such location; and
c) providing for essentially each such advertising display unit to assist Internet access for location customers.

2) The method according to claim 1 further comprising:
a) providing a wireless electronic connectivity system structured and arranged to couple each advertising display unit of said plurality of advertising display units to at least one electronic device having a designated local wireless connectivity.

3) The method according to claim 1 further comprising:
a) providing at least one video-conferencing interface structured and arranged to provide at least one video-conferencing interface between at least one first location-customer and at least one second location-customer in real-time.

4) The method according to claim 1 further comprising:
a) providing, for purchase by and delivery to such media buyer, of marketing data collected at each advertising display unit.

5) The method according to claim 2 further comprising:
a) providing at least one video-conferencing interface structured and arranged to provide at least one video-conferencing interface between at least one first location-customer and at least one second location-customer in real-time; and
b) providing, for purchase by and delivery to such media buyer of marketing data collected at each advertising display unit.

6) An Internet client-server system, comprising, in combination:
a) at least one advertising delivery system comprising at least one computer server;
b) a plurality of advertising display units, essentially each said advertising display unit comprising at least one client computer, electronically coupled to said at least one advertising delivery system; and
c) a control system, comprising said at least one advertising delivery system and each of said plurality of advertising display units, structured and arranged to control a time and location of a targeted advertising message output from each of at least one subset of said plurality of advertising display units;
d) wherein essentially each of said plurality of advertising display units comprise at least one access system structured and arranged to assist a plurality of users to access the Internet.

7) The system according to claim 6 wherein said at least one access system comprises at least one wireless electronic connectivity system structured and arranged to couple each advertising display unit of said plurality of advertising display units to at least one electronic device having a designated local wireless connectivity.

8) The system according to claim 6 wherein personnel of said at least one advertising delivery system may control in real-time said time and location of said targeted advertising message output from each of said subset of said plurality of advertising display units.

9) The system according to claim 6 further comprising at least one video camera, electronically coupled to each of a second subset of said plurality of display units, structured and arranged to transmit video information to said at least one advertising delivery system.

10) The system according to claim 6 wherein each of a third subset of said plurality of advertising display units comprises a subdivided window comprising separate windows for at least:
a) media content;
b) advertising; and
c) web-cam views.

11) The system according to claim 6 further comprising at least one video-conferencing system, having video-conferencing capability, structured and arranged to be controlled by said control system.

12) The system according to claim 6 wherein said control system comprises at least one software control system structured and arranged to control the time and location of a targeted advertising message output from each of said plurality of advertising display units.

13) The system according to claim 12 wherein said at least one software control system further comprises:
a) at least one media-buyer computer interface structured and arranged to interface with at least one media buyer;
b) at least one location-operator computer interface structured and arranged to interface with at least one location operator of at least one advertising display unit; and
c) at least one location-customer interface structured and arranged to interface with at least one location customer.

14) The system according to claim 13 wherein said at least one software control system further comprises:
a) at least one location-customer interface structured and arranged to interface with at least one location customer while such location customer is operating an electronic device having a local wireless connectivity to at least one advertising display unit.

15) The system according to claim 14 wherein said at least one software control system further comprises:
a) at least one video-conferencing interface structured and arranged to provide at least one video-conferencing interface between at least one first location-customer and at least one second location-customer in real-time.

16) The system according to claim 7 further comprising:
a) at least one video camera, electronically coupled to each of a second subset of said plurality of display units, structured and arranged to transmit video information to said at least one advertising delivery system; and
b) at least one video-conferencing system, having video-conferencing capability, structured and arranged to be controlled by said control system;
c) wherein personnel of said advertising delivery system may control in real-time said time and location of said targeted advertising message output from each of said subset of said plurality of advertising display units; and
d) wherein each of a third subset of said plurality of advertising display units comprises a subdivided window comprising separate windows for at least:
i) media content;
ii) advertising;
iii) and web-cam views.

17) The system according to claim 16 wherein said control system comprises:
a) at least one software control system structured and arranged to control the time and location of a targeted advertising message output from each of said plurality of advertising display units;
b) wherein said at least one software control system further comprises:
i) at least one media-buyer computer interface structured and arranged to interface with at least one media buyer;
ii) at least one location-operator computer interface structured and arranged to interface with at least one location operator of at least one advertising display unit; and
iii) at least one location-customer interface structured and arranged to interface with at least one location customer.

18) The system according to claim 17 wherein said at least one central software control system further comprises at least one location-customer interface structured and arranged to interface with at least one location customer while such location customer is operating an electronic device having a local wireless connectivity to at least one advertising display unit.

19) The system according to claim 18 wherein said at least one central software control system further comprises at least one video-conferencing interface structured and arranged to provide at least one video-conferencing interface between at least one first location-customer and at least one second location-customer in real-time.
